(19) United States
(12) Patent Application Publication
(10) Pub. No.: US 2007/0150540 A1
(43) Pub. Date: Jun. 28, 2007

(54) Presence and peer launch pad

(75) Inventors: Christopher G. Kaler, Sammamish, WA (US); Gopala Krishna R. Kakivaya, Sammamish, WA (US); Hervey O. Wilson, Bellevue, WA (US); Richard L. Hasha, Seattle, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/318,768

(22) Filed: Dec. 27, 2005

(51) Int. Cl. G06F 15/16

(52) U.S. Cl. 709/205

(57) ABSTRACT

Managing peer-to-peer application components. A method may be performed, for example, at a computer system that includes application components including peer-to-peer application components. The peer-to-peer application components allow the computer system to communicate with other agents, such as host computers, operating systems, frameworks, application code and the like, in a peer-to-peer fashion. The computer system includes a launch pad module for coordinating the peer-to-peer application components. The method includes providing an extensible interface that allows peer-to-peer application components to be registered with the launch pad module. Peer-to-peer application components are registered with the launch pad module. Requests are accepted from agents directed to the peer-to-peer application components registered with the launch pad module. Launch functions are performed for the peer-to-peer application components registered with the launch pad module in response to the requests.

### BACKGROUND

### Background and Relevant Art

Modern computers often include functionality for connecting to other computers. For example, a modern home computer may include a modem for dial-up connection to internet service provider servers, email servers, directly to other computers, etc. In addition, nearly all home computers come equipped with a network interface port such as an RJ-45 Ethernet port complying with IEEE 802.3 standards. This network port, as well as other connections such as various wireless and hardwired connections can be used to interconnect computers.

Computers can be interconnected in various topologies. For example, one topology is a client-server topology. In a client server topology, a central authority maintains control over the network organization. The central authority can provide routing functionality by providing network address to clients on the network. When the central authority becomes disabled or non-functional, network communications can be hampered or completely disabled.

Another topology is a peer-to-peer topology. In a peer-to-peer topology, peers on a network use peer-to-peer protocols to become aware of one another and to send messages to one another. Peer-to-peer networks are formed as a self selected group assembled for a purpose. Peers in a peer-to-peer network can affect live communication to other peers in a peer-to-peer network. Peers can also provide other peers with an indication of their liveness or availability on a peer-to-peer network.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment described herein includes a method of managing peer-to-peer application components. The method may be performed, for example, at a computer system that includes application components including peer-to-peer application components. The peer-to-peer application components allow the computer system to communicate with other agents, such as host computers, operating systems, frameworks, application code and the like, in a peer-to-peer fashion. The computer system includes a launch pad module for coordinating the peer-to-peer application components. The method includes providing an extensible interface that allows peer-to-peer application components to be registered with the launch pad module. Peer-to-peer application components are registered with the launch pad module. Requests are accepted from agents directed to the peer-to-peer application components registered with the launch pad module. Launch functions are performed for the peer-to-peer application components registered with the launch pad module in response to the requests.

Another embodiment includes a method of tracking liveness of peers on a peer-to-peer network. The method may be practiced, for example, at a computer system that includes application components including peer-to-peer application components for communicating with other agents in a peer-to-peer fashion. The computer system may include a launch pad module for coordinating the peer-to-peer application components. The method includes providing an extensible interface that allows peer-to-peer application components to be registered with the launch pad module. The peer-to-peer application components are registered with the launch pad module. One or more common publishing points are queried using generic publication and subscription functions to determine liveness of peers.

Another embodiment includes a computer system for communicating with other agents in a peer-to-peer fashion. The computer system includes a processor configured to run program modules. A storage medium is configured to store data and program modules. The storage medium includes program modules. The program modules implement an extensible interface configured to allow one or more peer-to-peer application components to be plugged into the interface. The program modules further implement a launch pad module configured to manage the peer-to-peer application components.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Various features and advantages may be realized and obtained by means of the instruments and combinations particularly pointed out in the appended claims. These and other features will become more fully apparent from the following description and appended claims, or may be learned by the practice of the teachings as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments thereof which are illustrated in the appended drawings. Understanding that these drawings depict only typical embodiments and are not therefore to be considered to be limiting scope, the embodiments will be described and explained with additional specificity and detail through the use of the accompanying drawings in which:

FIG. 1 illustrates an exemplary system including a peer launch pad and application components;

FIG. 2 is a flow chart illustrating a method of managing peer-to-peer application components;

FIG. 3 is a flow chart illustrating a method of tracking liveness on a peer network; and

FIG. 4 illustrates an exemplary system where some embodiments may be practiced.

### DETAILED DESCRIPTION

The embodiments described herein may comprise a special purpose or general-purpose computer including various computer hardware, as discussed in greater detail below.

One embodiment illustrated herein includes an extensible peer launch pad. The peer launch pad includes an interface that allows peer-to-peer application components to register with the peer launch pad. The peer launch pad is extensible in that it can register different application components that may or may not have been designed for use with the peer launch pad and coordinate common peer-to-peer activities. The peer launch pad can accept requests directed to peer-to-peer application components registered with the peer launch pad. When a peer launch pad accepts a request directed to one of the peer-to-peer application components registered with the peer launch pad, the peer launch pad can then perform launch functions such as executing the application component, connecting to an already executing application component and or alerting a user and providing a user interface element that allows the user to launch the application component. Users launching application components can include, for example, executing a new application component and/or connecting to an already existing application component. When performing launch functions, the peer launch pad can use certain rules to allow or disallow communications as will be discussed in more detail below. The peer launch pad can also provide universal presence information for any or all peer-to-peer application components registered with the peer launch pad so as to eliminate the need for redundant entering of presence information in each of the peer-to-peer application components. In other words, the different presence mechanisms of different peer-to-peer application components can be coordinated using a universal presence function. Further, the peer launch pad can gather presence information using generic publication/subscription services.

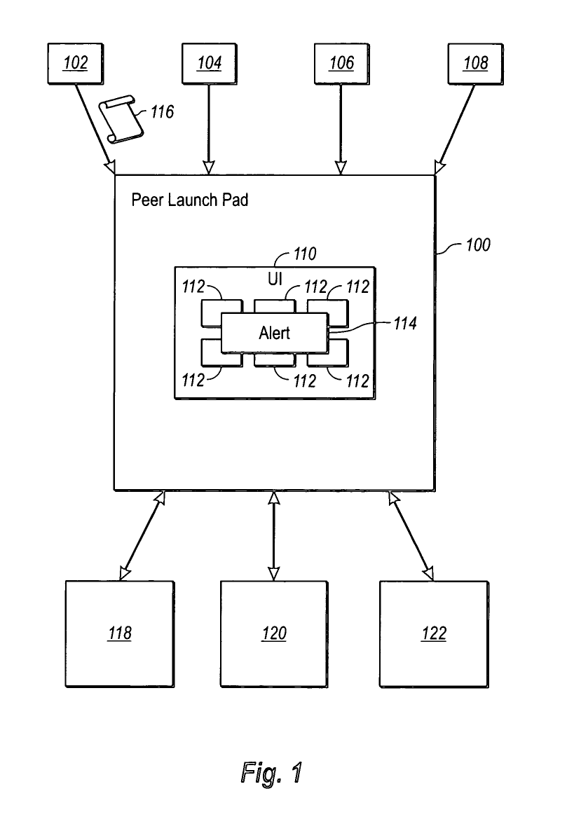

Referring now to FIG. 1, an exemplary embodiment is illustrated. FIG. 1 illustrates a block diagram which includes a peer launch pad 100. The peer launch pad 100 includes an extensible interface that allows peer-to-peer application components to register with the peer launch pad 100. This allows the peer launch pad 100 to receive requests from remote peer agents. For example, FIG. 1 illustrates peer agents 102 through 108. The peer agents 102 through 108 may be peers on the same peer-to-peer network as one or more peer-to-peer application components registered with the peer launch pad 100. Alternatively, one or more of the peer agents 102 through 108 may be peer services that track peers on a peer-to-peer network. For example, a peer-to-peer type connection relates to instant messaging clients. Instant messaging clients allow users that are connected to a network to accomplish a real-time chat communication. To accomplish some of the functionality related with instant messaging applications, a central server may often be used to track the state of a user at a computer terminal and to provide routing information to computers that may wish to contact one another. In one embodiment, the instant messaging server may be embodied as one of the peer agents 102 through 108. In alternative embodiments, the peer agents 102 through 108 may include actual peers of peer-to-peer application components registered with the peer launch pad 100. Peer agents may be, for example, host computers, operating systems, frameworks, application code and the like.

FIG. 1 further illustrates that the peer launch pad 100 includes a user interface 110. While the user interface 110 is illustrated in this example as a display, the user interface 110 may include any kind of user or programmatic interaction point. In the specific example shown, the user interface 110 may include display elements such as icons 112 that allow a user to launch a peer-to-peer application component that has been registered with the peer launch pad 100. For example, in one embodiment, the user interface 110 includes an icon 112 for each peer-to-peer application component registered with the peer launch pad 100. This allows peer-to-peer launching functionality, including executing applications and connecting to existing applications, to be consolidated into a concise user interface 110.

The user interface 110 further includes an ability to provide alerts 114. The alerts 114 may be, for example, a popup box as illustrated in the user interface 110 shown in FIG. 1. Other examples of alerts 114 include pager messages, ring-tones, and the like. Illustrating now the alert functionality, the peer launch pad 100 may be configured to receive a request 116 from a peer agent 102. When the request 116 is received by the peer launch pad 100, the peer launch pad 106 may perform launch functions for a peer-to-peer application component registered with the peer launch pad 100 to which the alert 116 is directed. In one exemplary embodiment, the peer launch pad 100 will cause the user interface 110 to display the alert 114 indicating receipt of the request 116 and allow a user to launch the peer to peer-to-peer application component, such as by executing a new application or connecting to an already executing application, associated with the request 116.

Peer-to-peer messages, such as requests and responses, may be sent using, for example Web Services. Web Services is a standardized way of integrating applications. Standardized XML documents can be used with SOAP (Simple Object Access Protocol) messages and WSDL (Web Services Description Language) descriptions to integrate applications without an extensive knowledge of the applications being integrated.

In one alternative embodiment, the peer launch pad 100 may immediately launch the peer-to-peer application component associated with the request 116. In this embodiment, launching the peer-to-peer application component may occur in accordance with specified rules. These rules may take into account items such as but not limited to time-of-day, identity of peer agent 102 sending the request 116, priority of the request 116, type of request 116, authentication information, source region of the request, system activity, network conditions, specific types of activity, dynamic policy considerations, and so forth. Each of these factors may be used alone or in combination. For example, one rule may ignore requests from a particular agent between 9 A.M. to 5 P.M. The policy rules may also include further functionality that defines how requests and communications take place for any or all peer-to-peer application components registered with the peer launch pad 100. For example, one rule may restrict receipt of attachments for all peer-to-peer application components registered with the peer launch pad 100.

Embodiments where peer-to-peer application components may be launched by receipt of the request 116 can facilitate other extended functionality. For example, a peer agent, such as one of the peer agents 102-108 may include functionality to monitor for various events. For example, the agent may monitor stock prices, alarm systems, announcement information and the like. The agent may then issue a request 116 when an event occurs. Such events may include, a stock hitting a certain price, an alarm being activated, an announcement being made, etc. When the peer launch pad 100 receives the request, a peer-to-peer application component registered with the peer launch pad 100 may be launched to provide a user with an alert regarding the monitored event or to perform functionality related to the monitored event. Notably, the events may occur and monitoring may take place outside of the peer application components registered with the launch pad 100 and/or outside of the launch pad 100 itself.

FIG. 1 further illustrates further functionality that may be implemented in some embodiments. Specifically, FIG. 1 illustrates embodiments that can be used to track presence and liveness information for peers on a peer-to-peer network or for peer-to-peer communication. Presence information relates to information indicating that a user or application is on-line and available for live communication. FIG. 1 illustrates a number of publication and subscription points 118 through 122. The publication/subscription points 118 through 122 may be for example, publishing points where application components subscribe at startup and unsubscribe at shutdown. Commonly, publication/subscription points 118-122 allow subscribers to receive information published to the publication/subscription points 118-122. One common example of a publication/subscription point is an email alias. Presence tracking can be accomplished by using generic publication/subscription functions.

By using a number of publications/subscription points 118 through 122, a subscription list could be maintained in a distributed fashion across a peer group. This allows for presence and liveness tracking being accomplished using peer-to-peer type infrastructures to take advantage of the distributed nature of some peer-to-peer networks. Specifically, network robustness advantages available using distributed networks may be realized. For example, the publications/subscription points 118 through 122 may be distributed throughout a network. As such, presence information can be distributed throughout the network as well instead of at one common point. The launch pad 100 may include functionality such that a query for presence information is generated at the launch pad and routed to a number of different publications/subscription points 118 through 122 to facilitate creating a complete presence list for peers.

In one alternative embodiment, leases may be taken as opposed to subscriptions, such that timeouts can be used to ensure that the data is fresh. The leases may be any appropriate time value for an application component. For example, some leases may be for 15 minutes whereas leases for other more important clients may be as short as 1 minute or less.

In an alternative embodiment the publications/subscription system could activity ping for finer grained liveness and presence tracking. This functionality could be customized for a particular granularity and can be customized for each subscriber. For example, in some application components peer presence or liveness may need to be tracked every fifteen minutes. Other application components or for peers, presence information may be needed every five minutes. For important applications and peers, presence information may be needed more often. The generic publications/subscription system functionality could be used to implement this tracking.

Other embodiments may include specific APIs and/or protocols which can be used by foreign systems to integrate liveness and presence universally.

The launch pad 100 further includes universal presence functionality for coordinating presence information for each of the peer-to-peer applications registered with the launch pad. For example, the launch pad 100 may include a plug-in for each of the peer-to-peer applications registered with the launch pad 100. The plug-in registers liveness such as at a peer agent 102 and reports back to the peer launch pad 100. Liveness can be reported at the launch pad 100 through context specific presence, such as for example displaying presence information in a list of peer-to-peer application components.

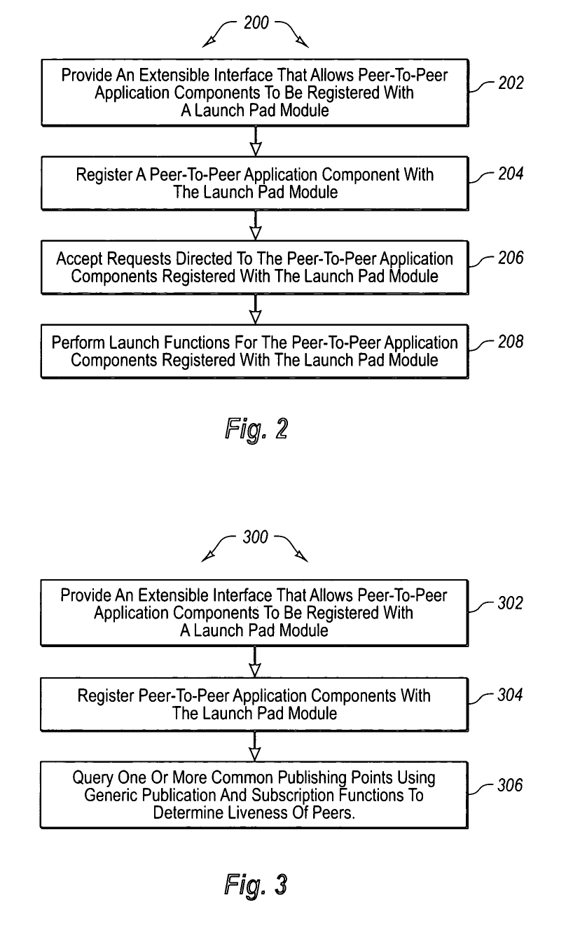

Referring now to FIG. 2, a method 200 of managing one or more peer-to-peer application components is illustrated. The method may be practiced for example at a computer system. The computer system may include application components including peer-to-peer application components for communicating with other systems in a peer-to-peer fashion. The computer system may include a launch pad module for coordinating the peer-to-peer application components. The method 200 includes an act of providing an extensible interface that allows peer-to-peer application components to be registered with the launch pad module (act 202). Providing an extensible interface (202) allows application components to be registered with the launch pad module, such as the peer launch pad 100 illustrated in FIG. 1. Extensibility allows for peer-to-peer application components that may not have been designed to specifically function with the launch pad module to nonetheless be registered with the launch pad module and to have activities coordinated through the launch pad module.

As such, the method 200 further includes an act of registering peer-to-peer application components with the launch pad module (act 204). Registering peer-to-peer application components with the launch pad module may include providing information to the launch pad module about the location of the peer-to-peer application components and what types of requests to monitor for a network for the peer-to-peer application components. Registering peer-to-peer application components with the launch pad module (act 204) may also include providing policy information such as rules that dictate when an application component registered with the launch pad module will be launched.

Notably, registering peer-to-peer application components (act 204) may be performed by pre-registering application components such that the launch pad has built in registrations. The extensibility of the launch pad allows for peer-to-peer application components to be registered with the launch pad prior to the launch pad being installed at a system.

When requests for the peer-to-peer application components are received through a network connection, the launch pad module accepts requests directed to peer-to-peer application components registered with the launch pad module (act 206). Requests can be directed to peer-to-peer application components in a number of different ways. For example, requests can be directed to a peer-to-peer application component by virtue of header information, a target address, a protocol being used, etc. Accepting requests directed to peer-to-peer application components (206) may include accepting requests from an intermediary. For example, an intermediary may be implemented in a topology to receive requests from a peer and to subsequently forward, such as in a store and forward scheme, the request to a peer-to-peer application component managed by the peer launch pad 100. One store and forward scheme is a peer mail listener that stores email messages and forwards them to other peers when the other peer become available for receiving messages.

The method 200 further includes an act of performing launch functions for the peer-to-peer application components registered with the launch pad module (act 208) in response to accepting requests directed to peer-to-peer application components registered with the launch pad module. In one embodiment, performing launch functions (208) includes launching the peer-to-peer application components. Launching the peer-to-peer application components may include, for example, executing and application, or connecting to an already executing application. Launching the peer-to-peer application components may be done according to a set of policies. For example, the policies may include considerations related to at least one of time of day, identity of provider being used, type of request, source identity of the request, authentication information, source region of the request, system activity, network conditions, and dynamic policy data. In an alternative embodiment, performing launch functions (act 208) may include prompting a user to launch the peer-to-peer application component.

The method 200 may further include in some embodiments an act of displaying a user interface. The user interface may include an indication of presence information for each peer-to-peer application component registered with the launch pad module. In one embodiment, the method 200 may include displaying a user interface that includes a selectable element that allows a user to launch one of the peer-to-peer application components. For example, the selectable element may allow a user to launch one of the peer-to-peer application components in the context of another party, set of parties, or peer group.

Referring now to FIG. 3, another embodiment is illustrated which includes a method of tracking liveness 300. The method may be performed, for example, at a computer system that includes application components including peer-to-peer application components for communicating with other systems in a peer-to-peer fashion. The computer system includes a launch pad module for coordinating the peer-to-peer application components. The method 300 includes an act of providing an extensible interface that allows peer-to-peer application components to be registered with the launch pad module (act 302). This may be accomplished as described above previously herein. The method 300 further includes an act of registering the one or more of the peer-to-peer application components with the launch pad module (act 304). As noted above, the launch pad module is extensible such that any one of a number of application components can register with the launch pad module.

The method also includes querying one or more common publishing points using generic publication and subscription functions to determine liveness of peers (act 306). The common publishing point may be for example an email alias or other publishing point. In one embodiment, the common publishing points are distributed such that presence information may be distributed in a peer-to-peer fashion. As described previously, a query may be generated at a launch pad and routed to a number of distributed publishing points.

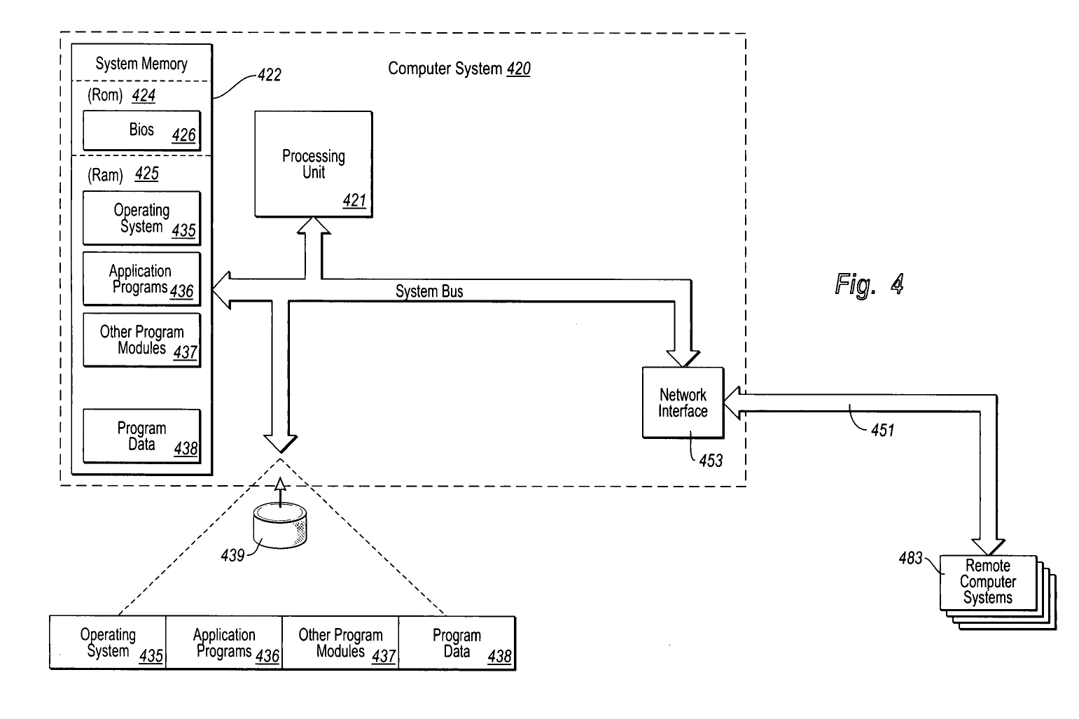

Referring now to FIG. 4, a computer system 420 is illustrated where embodiments may be implemented. The computer system 420 includes a processor 421 configured to operate on computer executable instructions such as instructions in the BIOS 426 stored in system memory 422 in the ROM 424, the operating system 435 stored on the hard disk 439 where it can be loaded into the RAM 525 of system memory 422, application programs 436, and other program modules 437. The computer system 420 may include, as mentioned above, storage media such the hard drive 439 and system memory 422 where data 438 and program modules 437 can be stored. The program modules 437 may be configured to implement an extensible interface configured to allow one or more peer-to-peer application components to be plugged into the interface. The program modules 437 may further include functionality to implement a launch pad module configured to mange peer-to-peer application components plugged into the interface.

The computer system 420 may further include a network connection 451 for connecting to remote computer systems 483. Such computer systems 483 may be for example peers or peer management systems. In one example, the remote computer systems 483 may be common publishing points. The computer system 420 may be configured to cause the launch pad module to query common publishing points using generic publication and subscription functions to determine liveness of peers.

The computer system 422 may further include functionality to perform launch functions. For example, as described above in conjunction with the preceding figures, the receipt of a request 116 (FIG. 1) by the computer system 422 may result in an application program 436 being launched or an alert that allows a user to manually launch an application program 436.

While not shown in FIG. 4, the computer system 420 may also include appropriate input devices and output devices. For example, the computer system 420 may include video hardware and a monitor to display the user interface 100 shown in FIG. 1. Additionally, the computer system 420 may include input hardware such as, but not limited to a keyboard and mouse, that allows a user to respond to alerts and to open peer application components. Those of skill in the art will appreciate that other configurations may also be implemented within the scope of the claims herein.

Embodiments, as described above, may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. At a computer system that includes application components including peer-to-peer application components for communicating with other agents in a peer-to-peer fashion such that communication occurs between the computer system and the other agents, the computer system including a launch pad module for coordinating the peer-to-peer application components, a method of managing one or more of the peer-to-peer application components, the method comprising:
providing an extensible interface that allows peer-to-peer application components to be registered with the launch pad module;
accepting requests from agents directed to the peer-to-peer application components registered with the launch pad module; and
performing launch functions for the peer-to-peer application components registered with the launch pad module in response to accepting requests directed to the peer-to-peer application components registered with the launch pad module.

2. The method of claim 1, wherein performing launch functions comprises launching the peer-to-peer application components registered with the launch pad.

3. The method of claim 2, wherein launching the peer-to-peer application components is done according to a set of policies.

4. The method of claim 3, wherein the policies include considerations related to at least one of time of day, identity of provider being used, type of request, source identity of the request, authentication information, source region of the request, system activity, network conditions, and dynamic policy data.

5. The method of claim 1, wherein performing launch functions comprises prompting a user to launch a peer-to-peer application component.

6. The method of claim 1, further comprising displaying a user interface, the user interface including an indication of presence information for each of one or more of the peer-to-peer application components registered with the control module.

7. The method of claim 1, further comprising displaying a user interface, the user interface including a selectable element that allows a user to launch one of the peer-to-peer application components in the context of another party, set of parties, or peer group.

8. The method of claim 1, wherein accepting requests directed to peer-to-peer application components registered with the launch pad module comprises accepting requests from an intermediary.

9. The method of claim 1, further comprising, querying one or more common publishing points using generic publication and subscription protocols to determine liveness of peers.

10. The method of claim 1, further comprising an act of exposing a programmatic interface, the programmatic interface providing universal presence information for the peer-to-peer application components registered with the launch pad module and providing an interface to perform the launch functions.

11. The method of claim 9, further comprising querying legacy and foreign presence system and determining liveness as a result of liveness being indicated by at least one of the queries to the publication subscription protocols, the legacy systems and the foreign systems.

12. A computer system for communicating with agents in a peer-to-peer fashion such that communication occurs between the computer system and the agents, the computer system comprising:
a processor configured to run program modules;
a storage medium configured to store data and program modules, the storage medium comprising program modules implementing:
an extensible interface configured to allow one or more peer-to-peer application components to be plugged into the interface; and
a launch pad module configured to manage the one or more peer-to-peer application components.

13. The computer system of claim 12, wherein the launch pad module is further configured to query one or more common publishing points using generic publication and subscription functions to determine liveness of peers

14. The computer system of claim 12, wherein the launch pad module is further configured to performing launch functions for the peer-to-peer application components.

15. At a computer system that includes application components including peer-to-peer application components for communicating with agents in a peer-to-peer fashion such that communication occurs between the computer system and the agents, the computer system including a launch pad module for coordinating the peer-to-peer application components, a method of tracking liveness of peers for one or more of the peer-to-peer application components, the method comprising acts of:
providing an extensible interface that allows peer-to-peer application components to be registered with the launch pad module;
registering the peer-to-peer application components with the launch pad module; and
querying one or more common publishing points using generic publication and subscription functions to determine liveness of peers.

16. The method of claim 15, further comprising displaying a user interface, the user interface including an indication of presence information for each of the peer-to-peer application components registered with the control module based on the act of querying one or more common publishing points.

17. The method of claim 15, further comprising displaying a user interface, the user interface including a selectable element that allows a user to launch one of the peer-to-peer application components.

18. The method of claim 15, wherein the common publishing point is an email alias.

19. The method of claim 15, wherein the common publishing points are distributed such that presence information can be distributed in a peer-to-peer fashion.

20. The method of claim 15, wherein the acts are performed using Web services as an interconnect protocol.
